(19) United States
(12) Patent Application Publication
(10) Pub. No.: US 2016/0304134 A1
(43) Pub. Date: Oct. 20, 2016

(54) LOCKING DEVICE AND ASSEMBLY FOR USE WITH A TRUCK TAILGATE MOUNTING HUB

(71) Applicant: VSI, LLC, Green Bay, WI (US)

(72) Inventors: Lucas Boesel, Muskego, WI (US); Joshua J. Miller, Milwaukee, WI (US); Daniel Bonness, Menomonee Falls, WI (US)

(21) Appl. No.: 15/130,081

(22) Filed: Apr. 15, 2016

Related U.S. Application Data
(60) Provisional application No. 62/147,778, filed on Apr. 15, 2015.

(51) Int. Cl. B62D 33/037

(52) U.S. Cl. CPC B62D 33/037

(57) ABSTRACT

A tailgate collar locking device encloses the slotted mounting hub of the tailgate, together with the pivot point stub within the mounting hub, within a portion of the locking device. The locking device of the present invention comprises a lock housing, a lock cylinder and a shackle. To prevent the theft of certain models of tailgate that are used in the marketplace, the locking device and assembly of the present invention further comprises a tabbed washer or shim that inhibits twisting of the locking device and does not allow the tailgate to be removed in those tailgate models.

This application claims the benefit and priority of U.S. Provisional Patent Application No. 62/147,778 filed Apr. 15, 2015.

### FIELD OF THE INVENTION

The present invention relates generally to locks and to other security devices that use locks and locking mechanisms. It also relates generally to pickup trucks of the type having a cargo space and a tailgate for accessing the cargo space. More specifically, the present invention relates to a locking device and an assembly that is used to prevent the removal of the truck tailgate by locking the device to a slotted hub of the tailgate and capturing a protruding pivot point stub, which stub is part of the truck bed.

### BACKGROUND OF THE INVENTION

Trucks, and pickup trucks in particular, typically have a cargo space that is disposed behind a passenger cab. Access to the cargo space is accomplished via a tailgate, which also serves to retain items within the cargo space when the truck is being driven. The tailgate includes a handle for unlatching the top of the tailgate and further includes a pair of slotted mounting hubs disposed to the bottom and both sides of the tailgate. The mounting hubs are intended to capture a pivot point stub to either side of the tailgate. In this way, the tailgate can be unlatched and rotated from a fully upright and substantially vertical position by about 90° to a substantially horizontal position. During this rotation, the protruding pivot pin stubs continue to be captured within the tailgate mounting hubs.

As alluded to, the tailgate mounting hubs are slotted such that, when the tailgate is at a certain angle, typically 45°, the pivot point stubs are capable of being passed through the tailgate hubs and the tailgate can be removed from the truck. This is possible because the pivot point stubs, which are typically round, are flattened on two sides. The flattened surfaces allow the pivot point stub to pass through the slot of the tailgate hub. This structure is desirable in that it allows a user to remove the tailgate with minimal or no tools. It is also desirable because it requires no other modifications to the vehicle. In order to prevent unauthorized removal of the tailgate, however, it is desirable to provide an anti-theft device and assembly that would prevent removal of the tailgate from the truck while still allowing the tailgate to maintain its full range of rotation. Further, such an anti-theft device and assembly should not interfere with the overall functionality of the tailgate.

### SUMMARY OF THE INVENTION

In the view of these inventors, what is needed is a tailgate collar locking device that can be used to deter the theft of a tailgate. The device should function by enclosing the slotted mounting hub of the tailgate, together with the pivot point stub within the mounting hub, within a portion of the locking device. The locking device of the present invention comprises a lock housing, a lock cylinder and a shackle. To prevent the theft of certain models of tailgate that are used in the marketplace, the locking device and assembly of the present invention further comprises a tabbed washer or shim that inhibits twisting of the locking device and does not allow the tailgate to be removed in those models.

The foregoing and other features of the tailgate collar locking device and assembly of the present invention will be apparent from the detailed description that follows.

### BRIEF DESCRIPTION OF THE DRAWINGS

FIG. 1 is an exploded perspective view of the tailgate collar locking device constructed in accordance with the present invention.

FIG. 2 is a partially sectioned elevational view of the tailgate collar locking device and showing the device in the unlocked position.

FIG. 3 is a view similar to that illustrated in FIG. 2 but showing the device in the locked position.

FIGS. 4A through 4D are side elevational views showing the installation of the tailgate collar locking device in various stages of attachment to the slotted tailgate hub and the tailgate pivot point stub within the hub, with FIG. 4D being a side elevational view of the tailgate collar locking device shown attached to the slotted tailgate mounting hub and the pivot point stub, with the tailgate in the full upright or closed position.

FIG. 5 is a view similar to that illustrated in FIG. 4D but showing the tailgate in a position where, without the tailgate collar locking device attached, the tailgate could be removed from the vehicle.

FIG. 6 is a perspective view of the shim that is used in the assembly of the present invention.

### DETAILED DESCRIPTION OF THE INVENTION

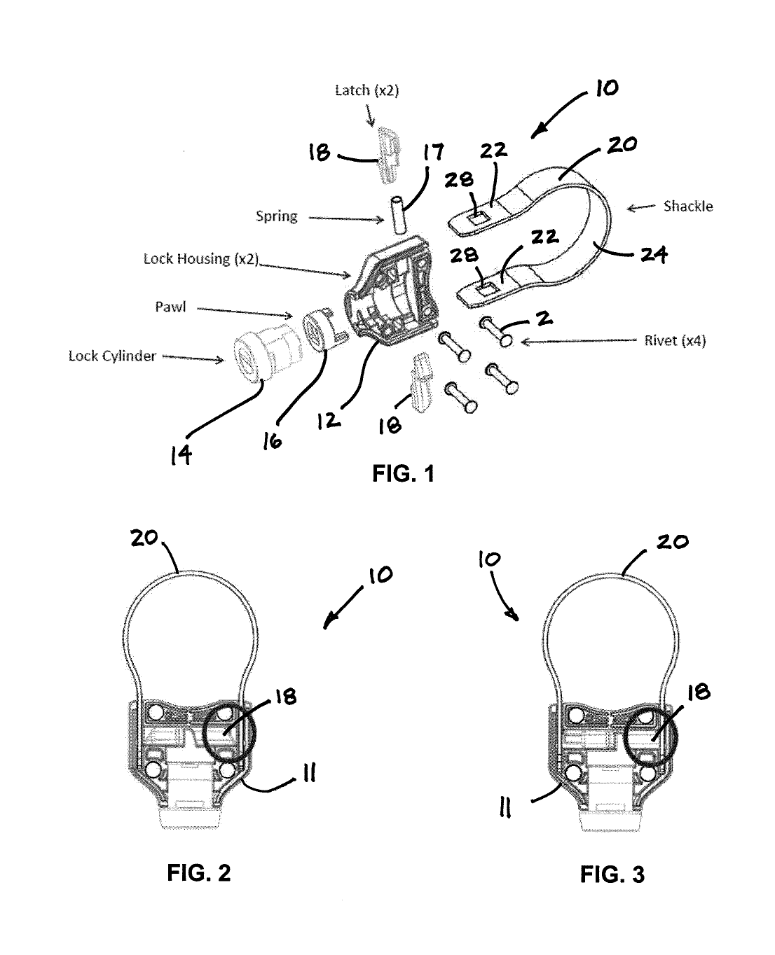

Referring now to the drawings in detail, FIG. 1 is an exploded perspective view showing a tailgate collar locking device, generally identified 10, constructed in accordance with the present invention. The locking device 10 comprises a pair of lock housing members 12, the pair forming a lock housing 11 when fastened together. The locking device 10 further comprises a lock cylinder 14, a lock pawl 16, spring 17, a pair of spring-loaded latches 18, a shackle 20 and a plurality of fasteners, such as rivets, 2 which fasteners are used to hold the lock housing members 12 together and to capture other components within the device 10 as well.

It is to be noted that the shackle comprises opposing straight ends 22 that are connected together by an arcuate center portion 24, the ends 22 and the center portion 24 being unitary and formed as a single structure. Each shackle end 22 comprises an aperture 28 formed in it. Although the apertures 28 are shown to be square, their shape is not a limitation of the present invention. Instead, their shape is dictated by the outer profile of the spring-loaded latches 18 that extend into the apertures 28 when the device is in its locked position.

Referring now to FIGS. 2 and 3, they show the locking device 10 in the unlocked position and the locked position, respectively. In the unlocked position, the latches 18 are pulled inwardly by rotating the lock pawl 16 by means of a key (not shown) used with the lock cylinder 14. In this position, the shackle 20 is able to be removed. In the locked position, an outward portion of the spring-loaded latches 18 protrudes through each of the apertures 28 formed in the shackle ends 22. That is, a spring 17 inside of the mated latches 18 forces the latches 18 outwardly, through the apertures 28 in both ends 22 of the shackle 20. When the proper key is installed, and turned, the rotating lock pawl 16 compresses the spring between the latches 18, thereby retracting the latches 18 from the shackle apertures 28 and allowing the shackle 20 to be removed from the lock housing 11.

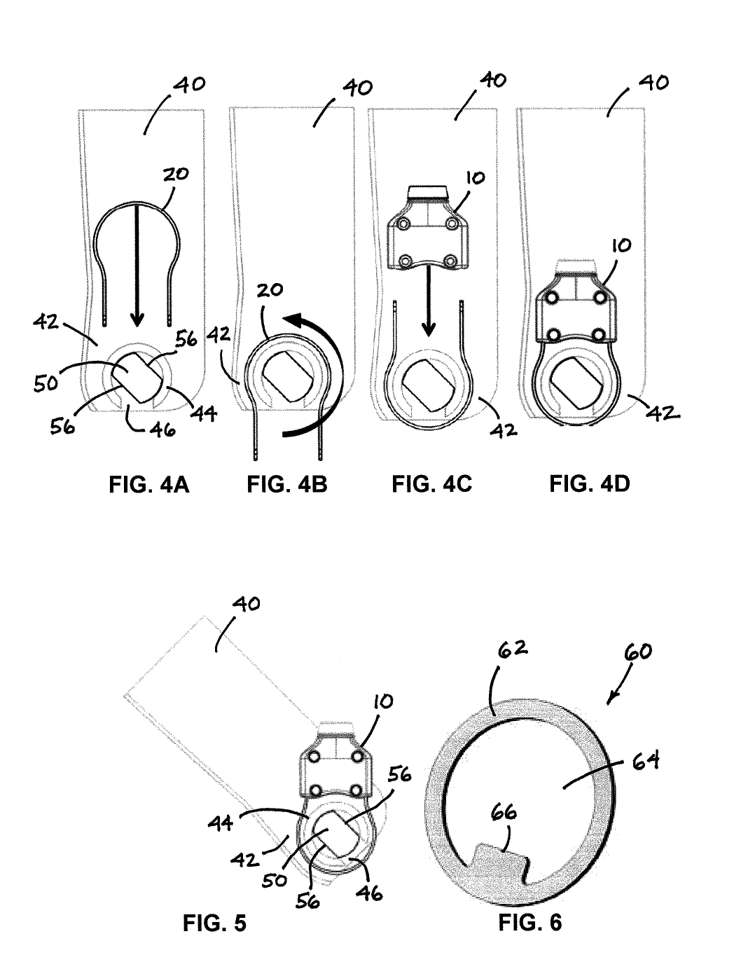

In application, FIGS. 4A through 4D will now be referred to. The lowermost portion 42 of a tailgate 40 is illustrated, as is the slotted tailgate hub 44, the hub 44 comprising an arcuate and open cylindrical structure, and the tailgate pivot point stub 50 within the hub 44, the tailgate 40 being in a full upright or vertical “closed” position relative to the cargo bed (not shown). As shown, the tailgate hub 44 comprises a stocky cylindrical structure having a slot 46 defined in it. Also as shown, the tailgate pivot point stub 50 comprises two opposing flat sides 56. In reference to FIG. 5, however, it can be appreciated that, when the tailgate 40 is opened to an angle of approximately 45°, the flat sides 56 of the tailgate pivot point stub 50 would allow the removal of the tailgate 40 via the slot 46 defined in the tailgate hub 44. As shown, it can be appreciated that the hub 44 is a hollow cylindrical structure having an opening 46 whereas the pivot point stub 50 is a solid cylindrical structure.

As shown in FIG. 4A, the shackle 20 of the locking device 10 is lowered downwardly toward the tailgate hub 44 and tailgate pivot point stub 50. Given its round profile, which bends slightly inwardly at its ends 22, the shackle 20 is secured to the tailgate hub 44 and tailgate pivot point stub 50. See FIG. 4B. The shackle 20 is then rotated such that its ends 22 are positioned generally upwardly at which point the lock housing 11 can be lowered and the device 10 secured to the tailgate hub 44 and tailgate pivot point stub 50. See FIGS. 4C and 4D.

As alluded to previously, and to prevent the theft of certain models of tailgate 40 that are used in the marketplace, the locking device 10 of the present invention is used within an assembly, which further comprises the use of a tabbed washer or shim 60 that inhibits twisting of the locking device 10 and does not allow the tailgate 40 to be removed in those models. As shown in FIG. 6, the shim 60 comprises a portion 62 that is formed substantially in the shape of a washer, the outer washer portion 62 comprising a circular aperture 64 that is of a diameter slightly larger than the diameter of the tailgate pivot point stub 50. Extending inwardly of the outer washer portion 62 and into the aperture 64 is a tabbed portion 66. This tabbed portion 66 has a width that substantially matches the slot 46 of the tailgate hub 44. The tabbed portion 66 of the shim 60 extends inwardly only to the point that would be the same as the thickness of the tailgate hub 44. This configuration is sufficient to inhibit twisting of the locking device 10 when the locking device is in place. In application, the shim 60 would be placed onto the tailgate hub 44 and tailgate pivot point stub 50 prior to placement of the shackle 20 to the same structures.

Lastly, it is to be appreciated that the slotted hub 44 and the pivot point stub 50 could be located on either the tailgate 40 or the truck bed (not shown) with the same functionality being accomplished as set forth in this disclosure. Additional advantages and modifications will readily occur to those skilled in the art. Therefore, the invention in its broader aspects is not limited to the specific details disclosed and described herein. Accordingly, various other modifications may be made without departing from the spirit or scope of the general inventive concept.

The details of the invention having been disclosed in accordance with the foregoing,

We claim:

1. A locking device for use with a truck tailgate mounting hub comprising:
a lock housing;
a lock cylinder;
a shackle; and
a tabbed washer;
wherein the tabbed washer inhibits twisting of the locking device and prevents removal of the locking device.

2. The locking device of claim 1 wherein the lock housing comprises a pair of lock housing members that form the lock housing when fastened together.

3. The locking device of claim 1 wherein the shackle comprises a pair of opposing straight ends that are connected via a center portion, the center portion and the ends being unitary in structure and each end comprising an aperture.

4. The locking device of claim 2 wherein the lock housing further comprises a spring and a pair of spring-loaded latches, the latches being complementary to the apertures disposed within the straight ends of the shackle to alternatively engage and disengage the latches with the apertures.

5. The locking device of claim 4 wherein the lock cylinder further comprises a pawl that is configured to move the latches into and out of engagement with the apertures of the shackle.

6. The locking device of claim 1 wherein the tabbed washer comprises a washer-shaped structure having an outer diameter and an inner aperture, the tabbed washer further comprising a tabbed portion that extends inwardly of the inner aperture.

7. A tailgate collar locking device for use with a tailgate pivot point stub, the pivot point stub comprising two opposing flat sides, and a truck tailgate mounting hub, the tailgate mounting hub comprising a slot through which the pivot point stub can be inserted into the mounting hub, the locking device comprising:
a lock housing;
a lock cylinder, the lock cylinder being disposed within the lock housing;
a shackle, the shackle being alternately inserted into and out of the housing; and
a shim;
wherein the shim inhibits twisting of the locking device about the tailgate pivot point stub and prevents removal of the locking device from the tailgate mounting hub.

8. The locking device of claim 7 wherein the shackle comprises a pair of opposing straight ends that are connected via a center portion, the center portion and the ends being unitary in structure and each end comprising an aperture.

9. The locking device of claim 8 wherein the lock housing further comprises a spring and a pair of spring-loaded latches, the latches being complementary to the apertures disposed within the straight ends of the shackle to alternatively engage and disengage the latches with the apertures.

10. The locking device of claim 9 wherein the lock cylinder further comprises a pawl that is configured to move the latches into and out of engagement with the apertures of the shackle.

11. The locking device of claim 7 wherein the tabbed washer comprises a washer-shaped structure having an outer diameter and an inner aperture, the tabbed washer further comprising a tabbed portion that extends inwardly of the inner aperture and is disposed within the slot of the tailgate mounting hub.

12. A tailgate locking assembly comprising:
a truck tailgate pivot point stub, the stub comprising a solid cylindrical structure having two opposing flat sides;
a truck tailgate mounting hub, the mounting hub comprising an arcuate hollow cylindrical structure and a slot through which the pivot point stub can be inserted into the mounting hub;
a lock housing;
a lock cylinder disposed within the lock housing;
a shackle that is alternately inserted into and removed from the lock housing; and
a tabbed washer;
wherein placement of the tabbed washer about the tailgate mounting hub inhibits twisting of the locking device about the tailgate pivot point stub and prevents removal of the locking device from the tailgate mounting hub.

13. The assembly of claim 12 wherein the shackle comprises a pair of opposing straight ends that are connected via a center portion, the center portion and the ends being unitary in structure and each end comprising an aperture.

14. The assembly of claim 13 wherein the lock housing further comprises a spring and a pair of spring-loaded latches, the latches being complementary to the apertures disposed within the straight ends of the shackle to alternatively engage and disengage the latches with the apertures.

15. The assembly of claim 14 wherein the lock cylinder further comprises a pawl that is configured to move the latches into and out of engagement with the apertures of the shackle.

16. The assembly of claim 12 wherein the tabbed washer comprises a washer-shaped structure having an outer diameter and an inner aperture, the tabbed washer further comprising a tabbed portion that extends inwardly of the inner aperture and is disposed within the slot of the tailgate mounting hub.
